(19) United States
(12) Patent Application Publication
(10) Pub. No.: US 2007/0010326 A1
(43) Pub. Date: Jan. 11, 2007

(54) VIDEO GAMING DISPLAY WITH MOVEABLE INDICATOR AND METHODS OF USE

(75) Inventors: Jerald C. Seelig, Pleasantville, NJ (US); Lawrence M. Henshaw, Pleasantville, NJ (US)

Correspondence Address: IAN F. BURNS & ASSOCIATES, P.O. BOX 71115, RENO, NV, 89570, US

(73) Assignee: Atlantic City Coin & Slot Service Company, Inc., Pleasantville, NJ (US)

(21) Appl. No.: 11/531,242

(22) Filed: Sep. 12, 2006

Related U.S. Application Data
(63) Continuation-in-part of application No. 11/143,140, filed on Jun. 1, 2005.
(60) Provisional application No. 60/716,756, filed on Sep. 12, 2005.

(51) Int. Cl. A63F 13/00

(52) U.S. Cl. 463/31

(57) ABSTRACT

A gaming device includes a video gaming display and a mechanical indicator. The gaming device has a video display that can display several prize positions. A moveable indicator points to at least one of the prize positions. A controller is in communication with the video display and the moveable indicator. The controller causes the moveable indicator to move to a selected position and the video display to display a video presentation. The controller further causes the video display to display a prize indicia such that the moveable indicator and video display in combination indicate a game outcome.

### CROSS REFERENCE TO RELATED AND CO-PENDING APPLICATIONS

The present patent application is a continuation-in-part application of U.S. patent application Ser. No. 11/143,140, filed Jun. 1, 2005 and further claims priority to U.S. provisional patent application having Ser. No. 60/716,756, filed on Sep. 12, 2005, all of which is incorporated by reference.

### BACKGROUND OF THE INVENTION

1. Field of the Invention

The present invention relates to gaming devices and, more particularly, to a gaming device having a video display and a mechanical indicator.

2. Background

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number (hereinafter, both types are referred to as a “random number”).

The random number can be used to determine a game outcome. For example, the random number may then be compared to a predefined table to determine a corresponding outcome of the event. If the random number falls within a certain range of numbers on the table, the player may win the corresponding predefined prize. The table may also contain display information that allows the gaming device to generate a display that corresponds to the outcome of the game. The gaming device may present the outcome of the game on a large variety of display devices, such as mechanical spinning reels or video screens.

Some gaming devices award bonus prizes in addition to prizes that are awarded in a primary game. Of course, the prize in the primary game may simply be the opportunity to play the bonus game. A bonus prize is generally defined as a prize in addition to the prize obtained from the primary game and that is awarded to the player when a predefined event occurs. An example of a bonus game can be found in U.S. Pat. No. 5,848,932 to Adams. Adams discloses a primary game having three spinning game reels and a bonus game having a bonus display with one spinning wheel. The spinning wheel is divided into multiple sections, and each section has a symbol representing a prize. When predetermined indicia are displayed on the spinning game reels of the primary game, the wheel of the bonus display spins and stops. The bonus prize is displayed as the symbol on the wheel being pointed to by a pointer. The bonus prize is awarded in addition to any prizes awarded in the primary game. Another bonus game is disclosed in Baerlocher et al. (U.S. Pat. No. 6,336,863). Baerlocher et al. discloses a slot machine with a bonus award display. The bonus award display has a bonus wheel and a mechanical, movable pointer.

One of the problems associated with the devices disclosed in these references is that the outcome of the bonus game is communicated to the player almost immediately. When a bonus game is triggered, a bonus award is selected, displayed, and awarded to the player. The player can see what the outcome of the game is immediately after the pointers have stopped moving. What has long been needed is a device that utilizes intermediate steps between the occurrence of the bonus event and the awarding of the bonus prize to add an additional element of anticipation and excitement for the players. It is further desired that the intermediate steps involve an eye-catching display. Another problem associated with Adams and Baerlocher et al. is that they utilize a plain combination of wheel and pointer. The applicants have discovered more things that can be done to display devices to make them more attractive and interesting to play.

Generally, bonus prizes are awarded in order to increase the excitement and enjoyment experienced by players, which attracts more players to the game and encourages players to play longer. When this occurs, the gaming devices tend to be more commercially successful relative to other gaming devices. A shortcoming of present bonus games is that they do not sufficiently allow players to interact with the gaming device, including during bonus games.

Other attempts have been made to provide player interaction. U.S. Pat. No. 5,788,573 to Baerlocher et al. (hereinafter “Baerlocher”) purports to provide a gaming device with an electronic “wheel of fortune game.” Several flippers appear to indicate positions on the wheel. Baerlocher appears to suggest that the player may be allowed to choose which flipper is used to select an indicia on the wheel. However, the player does not appear to have any control over the position of the flipper and the flippers do not appear to be capable of moving to different positions.

U.S. Pat. No. 6,309,300 to Glavich (hereinafter, “Glavich”) and U.S. Pat. No. 6,439,995 to Hughs-Baird et al. (hereinafter “Hughs-Baird”) purport to suggest a gaming system having a bonus feature where a player may be allowed to select a number of selectable items, which may be prize representations, on a video display. Glavich and Hughs-Baird do not appear to suggest using prize indicators, moveable prize indicators, or allowing a player to position a prize indicator.

### SUMMARY

Advantages

The various embodiments of the present invention may, but do not necessarily, achieve one or more of the following advantages:

provide a highly attractive and entertaining device for conducting games;

provide a highly attractive and entertaining device for displaying prizes;

the ability to attract more patrons to play a game;

the ability to encourage players to play longer on a gaming apparatus;

provide at least one attractive prize indicator;

provide a unique combination of video presentation and moveable indicator;

provide a video display for displaying prize indicia and a moveable indicator configured to indicate one of the prize indicia;

provide a gaming device that shows prize indicia;

allow players to control the movement of a prize indicator;

provide an entertaining video presentation;

provide a display that simulates moving water;

provide a display that simulates a moving train;

provide a display that allows for a relatively large number of indicia to be displayed;

provide the illusion that the player can influence the outcome of a game;

provide a game that has multiple steps;

utilize intermediate steps between the occurrence of the bonus event and the awarding of the bonus prize;

provide an additional element of anticipation and excitement for players;

provide a display in which a mechanical indicator and a video display cooperate together to appear as an integrated display,

provide a game player the opportunity to select a prize position from several prize positions;

provide a game in which prize indicia are revealed to a player; and

provide a game in which symbols are used in a prize position

These and other advantages may be realized by reference to the remaining portions of the specification, claims, and abstract.

### BRIEF DESCRIPTION OF CERTAIN ASPECTS OF THE INVENTION

In one embodiment, the present invention comprises a gaming device. The gaming device includes a video display. The video display can display a plurality of prize positions. A moveable indicator points to at least one of the prize positions. A controller is in communication with the video display and the moveable indicator. The controller causes the moveable indicator to move such that it indicates at least one prize position and causes the video display to show a video presentation. The controller causes the video display to display the prize indicia that is indicated by the moveable indicator.

In one embodiment, the present invention comprises a gaming method. The gaming method includes presenting a video presentation. The video presentation may contain a plurality of prize positions where prizes may be displayed. A game outcome is determined. An indicator is positioned to indicate a prize position and a prize indicia is shown.

The above description sets forth, rather broadly, the more important features of the present invention so that the detailed description of the embodiments that follow may be better understood and contributions of the present invention to the art may be better appreciated. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Certain embodiments of the invention are shown in the accompanying drawings wherein:

FIG. 1 is substantially a front elevation view of an embodiment of the gaming apparatus of the present invention.

FIG. 2 is substantially a partial side cross-sectional view of FIG. 1.

FIG. 3 is substantially a schematic diagram of the gaming apparatus of FIG. 1.

FIG. 4 is substantially an enlarged front elevation view of the bonus game of FIG. 1 showing an initial video presentation.

FIG. 5 is substantially an enlarged front elevation view of the bonus game of FIG. 1 showing a second video presentation.

FIG. 6 is substantially an enlarged front elevation view of the bonus game of FIG. 1 showing a third video presentation.

FIG. 7 is substantially an enlarged front elevation view of the bonus game of FIG. 1 showing a fourth video presentation.

FIG. 8 is substantially a flowchart of a gaming method according to the present invention.

FIG. 9 is substantially a flowchart of a gaming method according to the present invention.

FIG. 10 is substantially a front elevation view of another embodiment of a gaming apparatus of the present invention.

FIG. 11 is substantially a partial top cross-sectional view of FIG. 10.

FIG. 12 is substantially a schematic diagram of the gaming apparatus of FIG. 10.

FIG. 13 is substantially an enlarged front elevation view of the bonus game of FIG. 10 showing an initial video presentation.

FIG. 14 is substantially an enlarged front elevation view of the bonus game of FIG. 10 showing a second video presentation.

FIG. 15 is substantially an enlarged front elevation view of the bonus game of FIG. 10 showing a third video presentation.

FIG. 16 is substantially an enlarged front elevation view of the bonus game of FIG. 10 showing a fourth video presentation.

FIGS. 17A and 17B is substantially a flowchart of a gaming method according to the present invention.

FIGS. 18A and 18B is substantially a flowchart of a gaming method according to the present invention.

### DESCRIPTION OF AT LEAST ONE EMBODIMENT OF THE PRESENT INVENTION

In the following detailed description of at least one embodiment of the present invention, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Game Apparatus

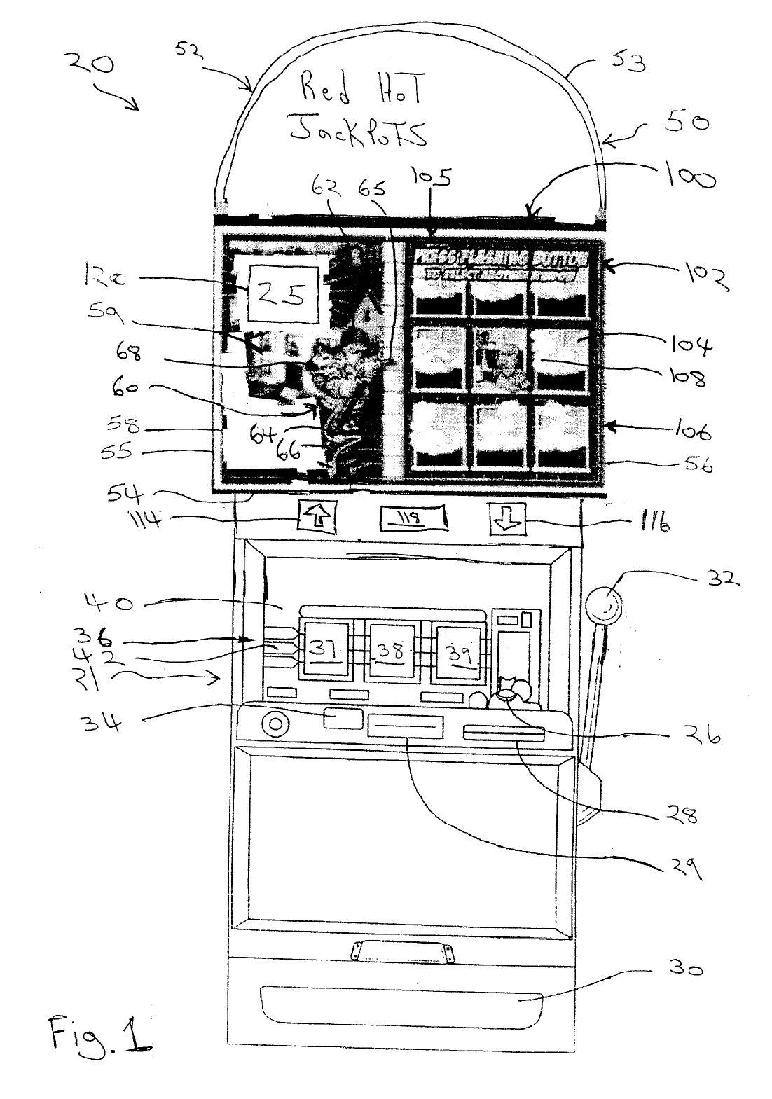

As seen in FIG. 1, the present invention comprises a game or gaming apparatus, generally indicated by reference number 20. In at least one embodiment, gaming apparatus 20 comprises a bonus game or second display 50 and a primary gaming device 21. Gaming device 21 may be any of a large number of devices that are adapted to allow players to play a game, such as gaming devices typically found in arcade and casino environments, including arcade games, video games, gambling machines, video poker machines, slot machines, etc. In at least one embodiment, gaming device 21 is further adapted to allow a player to place a wager and play a game, such as a slot machine.

Gaming device 21 may include a value acceptor for accepting value (including currency and/or currency equivalents), such as a coin slot 26, card reader 28, or a voucher reader 29. In addition, a payout mechanism (not shown) and a coin receptacle 30 may be provided for awarding prizes or for dispensing value to players cashing out and retiring from a game. A printer (not shown) may also be provided for printing out cashless vouchers (not shown). A handle 32 and a button 34 may be provided for activating gaming device 21 to begin a game. A pay table (not shown) may further be provided to allow a player to see what symbol or combination of symbols provide a winning event. In at least one embodiment, gaming device 21 may be a S2000 or S Plus model gaming device manufactured by International Game Technology in Reno, Nev.

Gaming device 21 may further include a gaming outcome display 36 that may be positioned in front of the gaming device 21 so that a player (not shown) playing gaming device 21 can see gaming outcome display 36. Gaming outcome display 36 may utilize physical game reels 37, 38, and 39. Game reels 37, 38, and 39 may be attached to a drive mechanism (not shown) of gaming device 21 to rotate the reels in a manner well known in the art. Each game reel 37, 38, and 39 may have a plurality of symbols positioned on the circumference of each game reel 37, 38, and 39. Game reels 37, 38, and 39 may be positioned side-by-side with coincident axes of rotation and a portion of their individual circumferences may face outward from gaming device 21.

A panel 40 may cover game reels 37, 38, and 39 such that only a portion of their individual circumferences are shown to the player. At least one symbol from any of game reels 37, 38, and 39 may be used to display a game outcome. At least one pay line 42 may be provided for the player to use in determining a game outcome based on the symbol or a combination of symbols positioned thereon. In an alternative embodiment, gaming outcome display 36 utilizes a video display (not shown) displaying images of game reels and an image of at least one pay line. A video display may also display game symbols in many other formats and arrangements, such as playing cards. Of course, the invention is not limited to any particular type of gaming outcome display 36. Those of skill in the art will recognize that many different types of gaming outcome displays could be substituted without departing from the scope of the present invention.

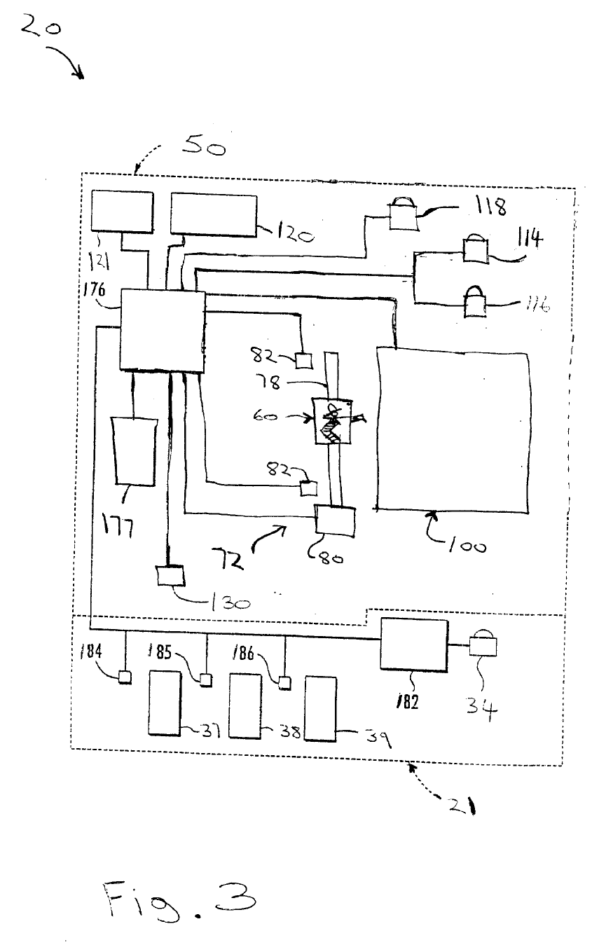

Gaming device 21 is preferably controlled by an electronic controller 182 (see FIG. 3) that utilizes a random number generator. The random number generator produces a random or pseudo random number for each game. The outcome of the game may be determined by comparing the random number to a table of outcomes stored in a memory and accessed by controller 182. A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, and U.S. Pat. No. 5,456,465, issued to Durham. Controller 182 causes spinning reels 37-39 to show the outcome of the game that corresponds to the outcome of the random number generator. It is recognized that gaming device 21 may operate in many other ways and still achieve the objects of the present invention.

Gaming device 21 may also be capable of producing a bonus-activating event. This event may be many different types of events. For example, a bonus-activating event may comprise displaying a particular symbol, such as a “bonus” symbol, or combination of symbols, such as three “7” symbols, on reels 37-39. If the game being played is poker based, the bonus-activating event may be occurrence of a certain hand, such as a royal flush. Furthermore, a bonus-activating event may occur when a player accumulates a number of symbols or game outcomes over a number of separate game plays. For example, a bonus-activating event may occur when the player receives three “bonus” symbols during a period of time. The bonus-activating event may be based on an external event. For example, a bonus-activating event may occur when a group of players obtain a certain result.

Bonus Game

Gaming apparatus 20 may include a bonus game or second display 50 configured to display at least one game and prize to a player. In at least one embodiment, second display 50 is configured to display a bonus game and at least one bonus prize to the player. In other embodiments, second prize display 50 may provide a primary game. Alternatively, second prize display 50 may be a stand-alone device allowing a player to place a wager and play a game.

In at least one embodiment, second display 50 is attached to gaming device 21 and positioned on top of gaming device 21. In other embodiments (not shown), second display 50 may be separate from gaming device 21 but in communication with gaming device 21. In this embodiment, second display 50 may be in communication with a plurality of different gaming devices 21 via a computer network in a manner that is well known in the art. Second display 50 may also be positioned adjacent to or remote from gaming device 21. In other embodiments, second display 50 is a stand-alone display not in communication with gaming device 21, and it may be capable of independently accepting wagers, conducting games, and awarding prizes to a player.

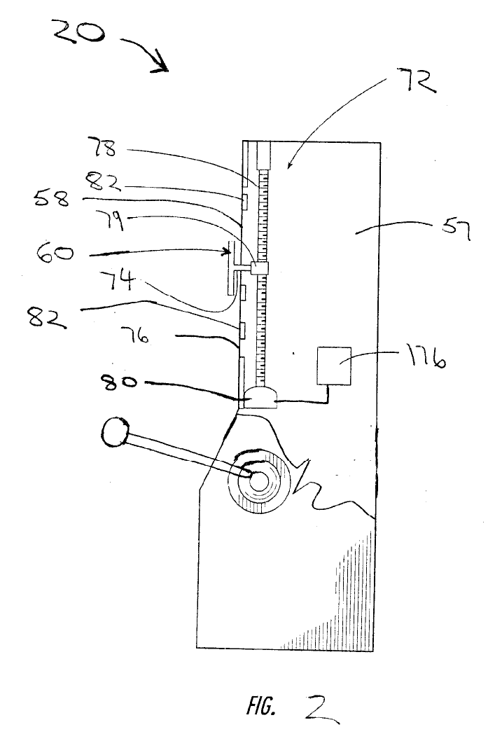

With continued reference to FIG. 1, second display 50 may comprise a housing 52. Housing 52 may be arc-shaped and comprise a top 53, a bottom 54 and side walls 55 and 56. The walls define an internal space or cavity 57 (see FIG. 2). Of course, housing 52 may be made in many different shapes. Second display 50 also may have a video display 100 and a moveable mechanical indicator 60. Video display 100 and indicator 60 may be positioned within housing 52.

A decorative front panel 58 may cover portions of video display 100 and indicator 60. Front panel 58 is shown having a house 59. Front panel 58 can also include a display 120 for displaying the amount of credits or the amount of a prize that is won during the game. Video display 100 can be a variety of video displays such as liquid crystal, cathode ray tube, plasma or projection displays.

The video presentations displayed on display 100 may be a wide variety of video presentations such as bonus presentations, a presentation to attract players to game apparatus 20, or a presentation to provide information to players.

The video presentation shown on display 100 may be designed in various forms and preferably according to a theme of a game. In the example shown in FIG. 1, the theme of the game is a fireman and a building that awards players various payouts. In an embodiment, display 100 can show a building 102 that may be on fire. Building 102 can have a matrix of prize positions 104 arranged in rows 105 and columns 106. Prize positions 104 are shown as windows in FIG. 1. A symbol 108 may be displayed in prize positions 104. The symbol 108 is shown as smoke and/or flames that appear to be pouring from the windows.

Indicator 60 may be a variety of indicators, including two and three-dimensional indicators. Indicator 60 may be configured to move vertically (up and down) relative to video display 100 in response to signals sent by a controller (described later). The number of indicators 60 may vary, and the direction of their movement may vary, and may include horizontal, zigzag, and/or diagonal movements.

The shape or appearance of indicator 60 may be designed in various forms and preferably according to a theme of a game. In the example shown in FIG. 1, the theme of the game is a fireman and a burning building that awards players various payouts. Accordingly, indicator 60 is in the form of a fireman 62 holding a fire hose 64. The fire hose has a nozzle 65. The nozzle 65 may appear to spray water in conjunction with video display 100. The fireman is standing on a fire truck ladder 66. The fireman is also holding a firehouse dog 68 such as a Dalmatian. Alternatively, indicator 60 may be other types of indicators or pointers, such as an arrow. Indicator 60 could be a policeman or soldier holding a gun. The present invention is not limited to any particular type of indicator or pointer, or any particular representation of an indicator or pointer.

Referring now to FIG. 2, indicator 60 may be coupled to a positioning mechanism 72 by a bracket 74. Positioning mechanism 72 may be located within the confines of housing 52. A slot 76 in the front panel 58 may be provided, which allows bracket 74 to pass through the front wall. Positioning mechanism 72 may comprise a vertically oriented threaded rod or worm gear 78 that is rotatable by an actuator 80. Indicator 60 may be attached to worm gear 78 by a bracket 74 that is attached to a nut 79 threaded on worm gear 78. Actuator 80 may be in communication with and controlled by controller 176.

Sensors 82 may be provided to allow a bonus game controller 176 or other control mechanisms (not shown), to detect the position of indicator 60. While indicator 60 is shown to move vertically in FIG. 2, it may be moved in any desired manner, including horizontally, diagonally, or in a non-linear fashion, such as in a rotating or zigzag manner.

In another embodiment, a wheel (not shown) may be attached to actuator 80. The periphery of the wheel may have at least one notch detectable by a sensor (not shown) and used by a bonus game controller 176. Wheel and worm gear 78 may be rotated together by actuator 80. The sensor monitors the position of indicator 60 by detecting the notch. Bonus game controller 176 may store information pertaining to the number of times the sensor has detected the notch and the corresponding position of moveable indicator 60. An optical interrupt (not shown) may be provided to reset the indicator position information. The sensor may be an infrared source and detector. In alternative embodiments, the periphery of the wheel may comprise portions with different reflective characteristics, such as absorbent paint lines, instead of a notch on the wheel. Actuators 80 may be a stepper motor, a servomotor, a gear motor, a solenoid, a rack and pinion, or other actuators known in the art.

Returning to FIG. 1, bonus or second display 50 also has player-input devices 114, 116 and 118 that allow the player to indicate his or her choice. In one embodiment, player input devices 114 and 116 are buttons that allow the player to select the direction of movement of indicator 60. For example, the player would press the left button 114 to move indicator 60 in an upward direction toward a different row 106 of prize positions. Similarly, the player would press the right button 116 to move indicator 60 in a downward direction toward a different row 106 of prize positions. Alternatively, a touch screen (not shown) may be provided in place of or in addition to buttons 114 and 116.

Player-input device 118 can be a button that allows the player to select another prize position 104 or window to display another prize. For example, if the game player does not receive a prize or is dissatisfied with the prize awarded, the player input device 118 can be flashed or illuminated. After player input device 118 is depressed, the game would select another prize position 104 and display another prize.

Player input devices 114, 116 and 118 allow a game player to partially control the outcome of bonus game 50. While the player is allowed to select which prize row 106 that indicator 60 is pointing toward, the final prize that is displayed and awarded is controlled by a controller.

The use of the player-input devices 114, 116 and 118 provides the game player with the illusion of a sense of control over the game. Of course, regulatory concerns may dictate that the player's perceived control be largely or completely illusionary.

Turning now to FIG. 3, second display 50 comprises a controller 176 that is adapted to control the operation of the game apparatus. Controller 176 may be one or more computers or processor boards. For example, in the presently implemented embodiment, controller 176 can be a bonus controller and stepper motor controller. Controller 176 and controller 182 may be combined in a single processor or processor board.

Controller 176 is adapted to detect when a bonus activating event occurs in game apparatus 21. This may be accomplished by game apparatus controller 182 transmitting a signal to controller 176 that a bonus event has occurred. For example, controller 182 may determine the outcome of each game and when a bonus-activating outcome occurs, it transmits a signal to controller 176. Alternatively, controller 176 may periodically interrogate controller 182. In another embodiment, one or more sensors may be provided for determining if a bonus activating event has occurred. For example, sensors 184-186 may sense the positions of reels 37-39. When reels 37-39 are in a bonus activating position, controller 176 would sense this position and begin a bonus sequence (described below). Sensors may also be provided external to gaming device 20 to detect external bonus-activating events.

Controller 182 may also transmit a variety of information to controller 176. For example, controller 182 may signal when coins or currency have been inserted, when a game starts, when an error has occurred, and when a sensor detects tampering.

When controller 176 detects a bonus-activating event, it may begin a bonus sequence by activating video display 100 and/or display 120. Display 120 may comprise many different kinds of display devices, such as video screens, lights, light emitting diodes, etc. Display 120 may comprise its own controller that is adapted to generate a variety of displays.

Video display 100 may present an entertaining video presentation after the bonus qualifying event. Display 120 may indicate that a player has qualified for a bonus round and prompt the player to perform an action. In one embodiment, the player is prompted to activate the bonus sequence by pressing input device 118. Input device 118 may be a simple button, a keyboard, or a touch screen display. In the embodiment in which the player must accumulate a number of bonus symbols to qualify for a bonus, display 120 may indicate the number of symbols the player has received.

Alternatively, display 120 can be part of video display 100. In this embodiment, display 120 would be shown as a window in video display 100.

Controller 176 is in communication with a video storage unit 177. Video storage unit 177 can be a wide variety of devices such as solid state memory, disk drives, compact discs or videotape. Video storage unit 177 can store a wide variety of video presentations.

When controller 176 detects input device 118 being activated, the controller would activate video display 100 and present a video presentation from video storage unit 117 on video display 100. Alternatively, a video presentation on video display 100 may begin automatically after the detection of a bonus qualifying event. In another embodiment, controller 176 may wait a predetermined time period for the player to activate input device 118. If the player does not activate input device 118 in that time period, controller 176 would automatically activate display 100.

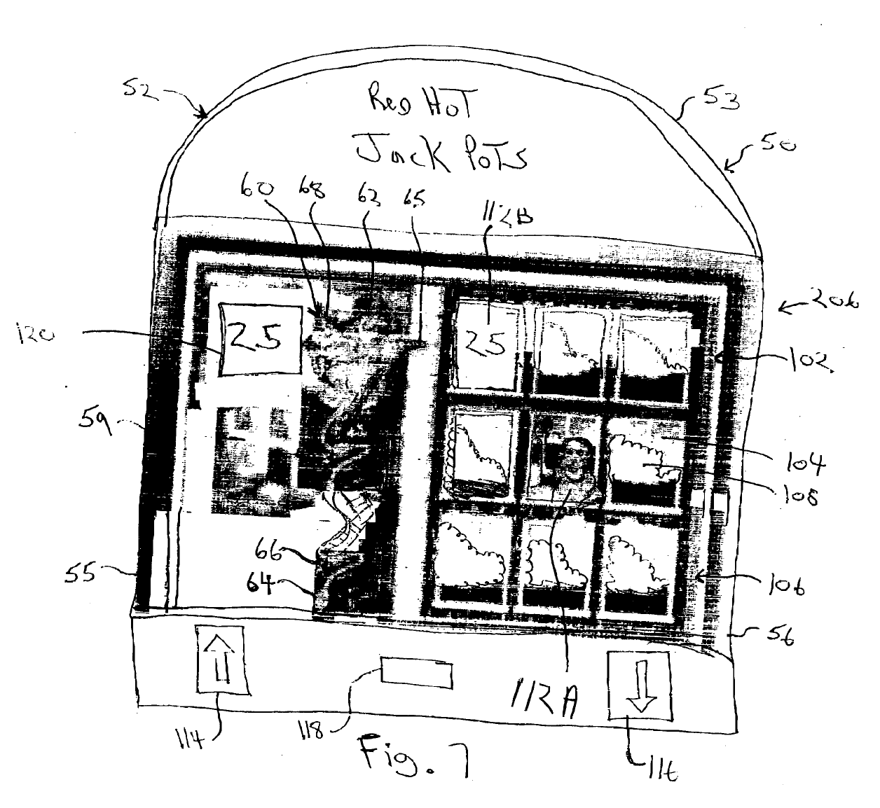

Controller 176 performs a routine to determine which prize indicia 112 (see FIG. 7) will be displayed to the game player in a particular prize position 104. Prize indicia 112 can represent various things, including prize amounts, multipliers, a description or representation of merchandise or services, progressive prizes, or jackpot prizes.

This may be performed by a number of methods that are well known in the art. For example, the prize indicia may be sequentially displayed or displayed based on external events.

In an embodiment, however, prize indicia 112 are randomly selected. Controller 176 generates a random number and then compares the random number to a pay table similar to that described for game apparatus 21 or as described in U.S. Pat. No. 5,823,874, issued to Adams. A simple pay table may appear as follows:

TABLE 1

| Random | Bonus | |
|---|---|---|
| Number | Credits | Amount Paid |
| 0.00 to 0.50 | 5 | $5.00 |
| 0.51 to 0.75 | 10 | $10.00 |
| 0.76 to 0.95 | 20 | $20.00 |
| 0.96 to 1.00 | 75 | $75.00 |

For example, if the random number generator produced 0.65, 10 credits would be displayed and $10.00 would be awarded to the player. If the random number generator produced 0.80, 20 credits would be displayed. Other awards, such as prize multipliers of some amount produced by game apparatus 50, can also be used. Gaming apparatus 50, for instance, may award $20 and the multiplier prize indicia would multiply this by two, awarding the player $40.

This embodiment is not necessarily limited to the example pay table shown. A greater number of prizes awards may be used and, as will be discussed below, a combination of prizes may be displayed. Furthermore, different kinds of prizes, besides monetary prizes, may be awarded. For example, the prizes may be goods, services, or additional games. The goods and services may be awarded in the form of physical objects, tickets, vouchers, coupons, etc. Additional games may be presented in the form of tickets, such as scratch off lottery tickets. In the embodiments in which tickets, vouchers, and coupons are used, the objects are dispensed using an internally or externally mounted dispenser 121. Such dispensers are well known in the art.

Once controller 176 determines the prize indicia 112 to be displayed and the prize to be awarded, the controller activates positioning mechanism 72. Positioning mechanism 72 is adapted to position indicator 60 so that at least one selected prize indicia 112 can be displayed. Positioning mechanism 72 may utilize a large variety of devices to achieve its purpose. In an embodiment, indicator 60 is moved up or down to a position to be in alignment with one of rows 106 (FIG. 1) shown on video display 100. Indicator 60 and video display 100, in combination, indicate a prize indicia 112.

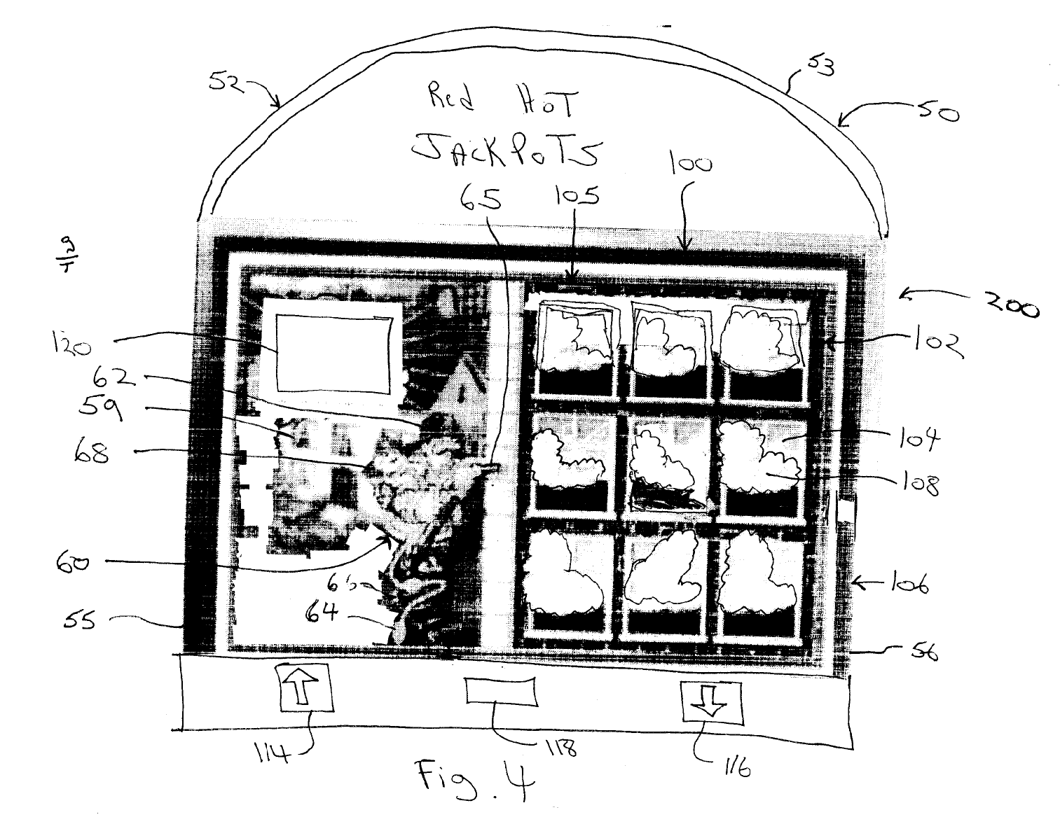

Tuning to FIG. 4 and with continued reference to FIG. 2, a first screen shot 200 of a video presentation on display 100 is shown. The screen shots are displayed sequentially on video display 100. In FIG. 4, display 100 can show a video presentation of a building 102 that is on fire. Building 102 can have a matrix of prize positions 104, shown as windows in building 102, that are arranged in rows 105 and columns 106. A prize position 104 is located in each window. A symbol 108 can be shown in prize position 104. In FIG. 4, the symbol 108 is shown as smoke and/or flames that appear to be pouring from the windows. Symbol 108 can be a wide variety of symbols and may match the theme of the game. Sound effects of sirens and fire trucks can also be presented during the video presentation on speaker 130.

After the first screen shot 200 has been shown, controller 176 directs positioning mechanism 72 to move indicator 60 to a position to be in alignment with an appropriate row 106 as selected by controller 176. Actuator 80 rotates worm gear 78 moving indicator 60. Sensors 82 are in communication with controller 176. Sensors 82 can determine the position of indicator 60. Indicator 60 can be stopped at the location determined by the random number generator.

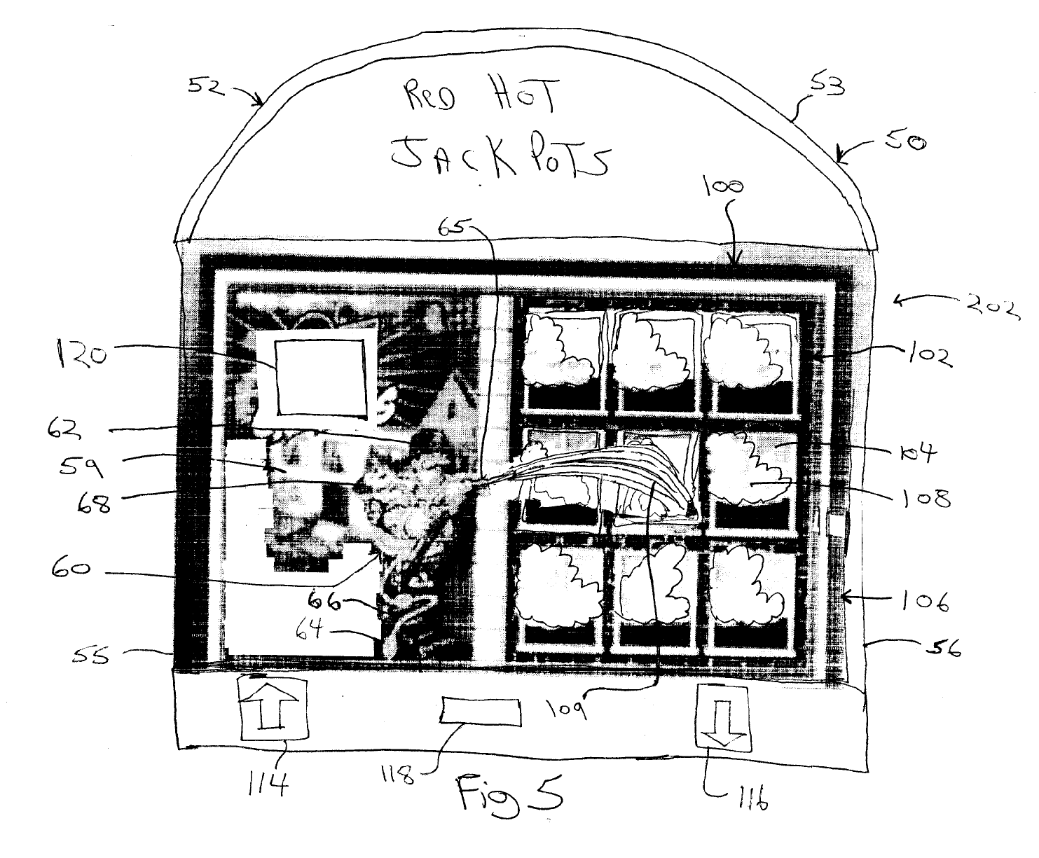

Turning to FIG. 5, a second screen shot 202 of a video presentation on display 100 is shown. In FIG. 5, display 100 can show a video presentation of water 109 being sprayed into one of the windows or prize position 104. It is noted that the video presentation is designed such that it appears that the water is leaving nozzle 65 of mechanical indicator 60 and is directed to flow into at least one of prize positions 104. In this embodiment, no real water is being dispensed from nozzle 65. Sound effects of flowing water can also be presented during this portion of the video presentation. The use of mechanical indicator 60 and video display 100 appear to a game player to interact as integrated presentation. The mechanical indicator appears to interact with the video presentation and provides an illusion of water flowing from nozzle 65. In an alternative embodiment, real water is sprayed and the video presentation displays other portions of the overall presentations.

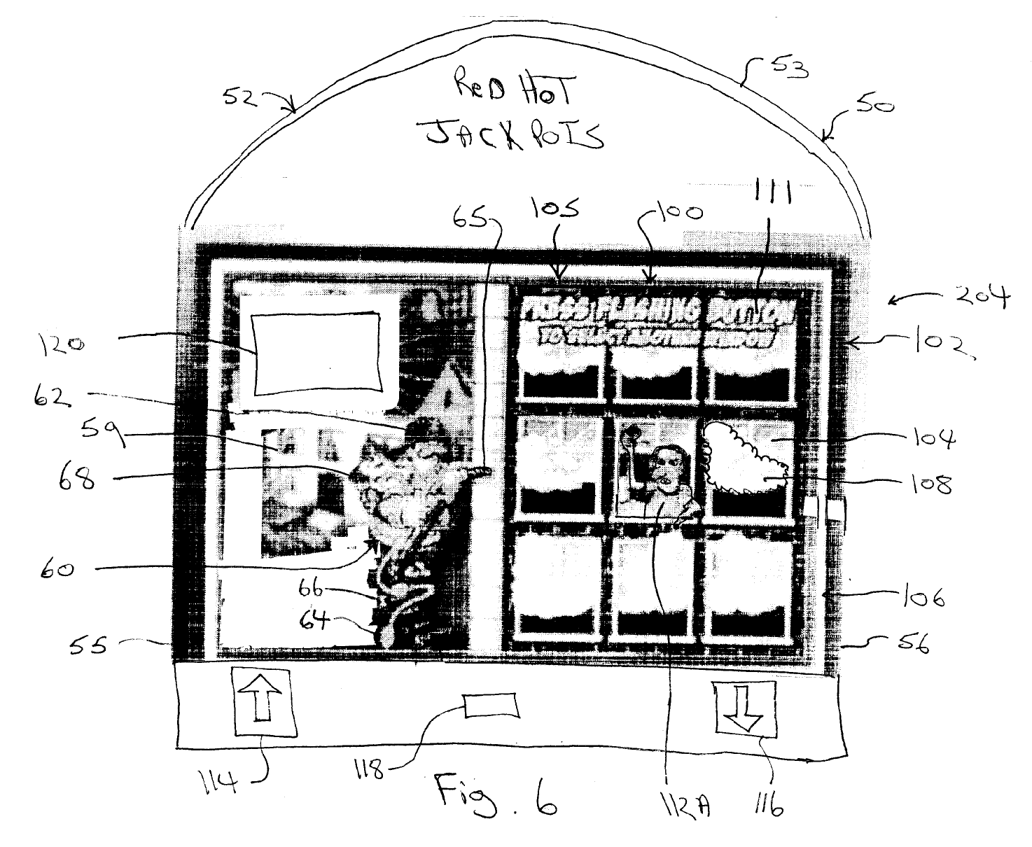

Turning to FIG. 6, a third screen shot 204 of a video presentation on display 100 is shown. In FIG. 6, display 100 can show a video presentation of the fire being put out in one of prize positions 104. A prize indicia 112A is shown in place of symbol 108. In the example shown in FIG. 6, the prize indicia 112A shown, is a losing or no prize indicia that is represented by an angry man. The video presentation may present the man as being upset at being soaked with water.

In the case of prize indicia 112 being a losing outcome, the video presentation can show instructions 111 on video display 100 instructing the game player to depress flashing button 118 in order to replay the game again and select another window to reveal a prize in.

Referring now to FIG. 7, a fourth illustration 206 of a video presentation on display 100 is shown. In FIG. 7, controller 176 has moved indicator 60 to be in alignment with another row 106. Video display 100 can then show a video presentation of the water being sprayed onto the fire and displaying the prize indicia in another prize position 104. In FIG. 7, a second prize indicia 112B is shown. Prize indicia 112B is shown as an award of 25 credits. Indicator 60 and video display 100, in combination, indicate prize indicia 112B.

Controller 176 may then cause video display 100 or 120 to display the prize, if any, that the player has won. Other effects may also be presented, such as pre-recorded sound from speakers. If the actual prize is money, the amount of the prize may be added to the player's credit meter or the prize may be dispensed from dispenser 121 or coin dispenser 27.

Combinations of prize indicia 112 can be used to indicate various bonus outcomes. For example, the contents of several prize positions 104 could be revealed and added together and awarded as a total prize to the game player.

In an alternative embodiment, a row 106 of prize positions 104 could be shown during a video presentation. Indicator 60 could then be positioned and appear to interact with the video presentation to spray water on to one of the prize positions 104 in order to indicate a game outcome.

It is also possible to replace the primary display of a gaming device with second display 50. Game apparatus 21 may be entirely replaced by second display 50. In other words bonus gaming apparatus 50 can be used as a primary or base game apparatus.

In another embodiment, the player could be allowed to select which row 106 of video display 100, that indicator 60 is positioned adjacent to. For example, the player could use player input devices 114 and 116 to select which row 106 displays a prize. The player could press the left button 114 to move indicator 60 upwards. The player can press the right button 116 to move indicator 60 downwards. Controller 176 would then direct video display 100 to show a video presentation to display the game outcome.

The bonus selection process may be repeated for a predetermined number of times to accumulate several bonus prizes that are added to form the award to the game player. For example, the bonus game could be repeated three times to accumulate an award.

Other effects may also be presented on video display 100, for example an entertaining non-game related video presentation can be shown. The non-game related video may be presented before the game has begun in an attract mode or can be presented during the game in order to enhance the entertainment value of the game.

Gaming Method

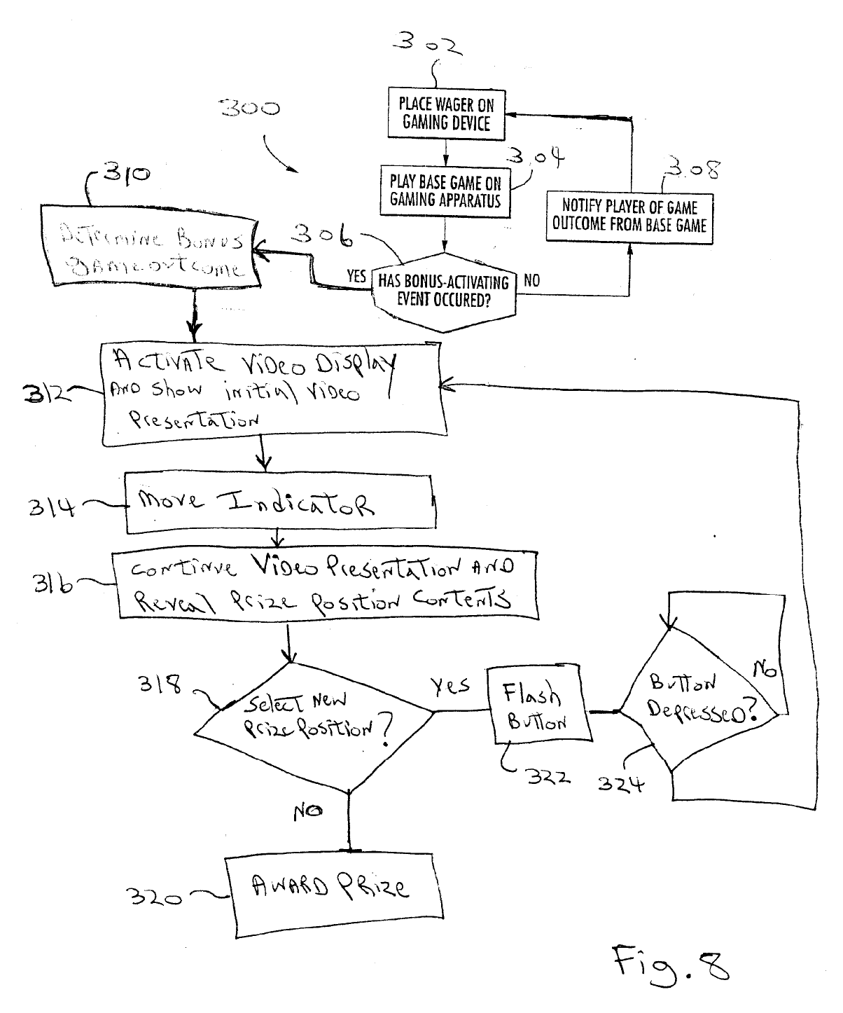

One method of operation 300 of gaming apparatus 20 of the present invention is illustrated in FIG. 8. A player places a wager on gaming apparatus 20 in step 302. Method 300 proceeds to allow the player to play a game and determine a game outcome in step 304. At decision 306, method 300 checks to see if the game outcome determined in step 304 is an outcome qualifying the player to play a bonus game. If not, method 300 proceeds to step 308, notifies the player of the game outcome and awards the player any prizes awarded according to the game outcome determined in step 304 and returns to step 302.

If it is determined in step 306 that the game outcome of step 304 qualifies the player for a bonus game, method 300 proceeds to step 310. At step 310, controller 176 randomly determines the game outcome or prize. At step 312, video display 100 is activated and an initial video presentation is presented. This may include activation of player input devices 114, 116 and 118. Lights and sounds may also be activated to make the event more exciting to the player and those around the player, as well as to call attention to the device.

Method 300 then proceeds to step 314 where indicator 60 is moved by positioning mechanism 72. Indicator 60 is moved until it is stopped and aligned with one of rows 106 on video display 100 as determined by controller 176. At step 316, controller 176 continues to present the video presentation including showing a prize indicia 112 that is in a prize position 104. Therefore, in combination, the indicator and the video display point to a prize indicia that corresponds to the game outcome. At decision 318, controller 176 checks to see if the result of step 316 is a prize award. If the result of step 316 is a prize award, method 300 proceeds to step 320 and awards any prizes. If the result of step 316 is not a prize award, method 300 proceeds to step 322. At step 322 a button 118 is illuminated or flashed. At decision 324, controller 176 checks to see if button 118 has been depressed. If button 118 has not been depressed, method 300 returns to decision 324 to await depression of button 324. If no input has been received after a pre-determined period of time, for example, 1 minute, controller 176 may make a selection for the player.

After button 118 has been depressed, method 300 proceeds to step 312 in order to repeat the bonus game steps of 312, 314, 316 and 318. These steps can be repeated a multiple number of times until a prize is selected to be awarded by controller 176 at step 320.

Many variations of method 300 can be made without departing from the scope of the present invention. For example, the prize indicia in several prize positions 104 could be shown before indicator 60 is moved. After the contents of prize positions 104 are shown, indicator 60 can be moved into alignment with one of rows 106 to point to one prize indicia 112 as the game outcome. Alternatively, the bonus game could be played separately without the use of base game apparatus 21.

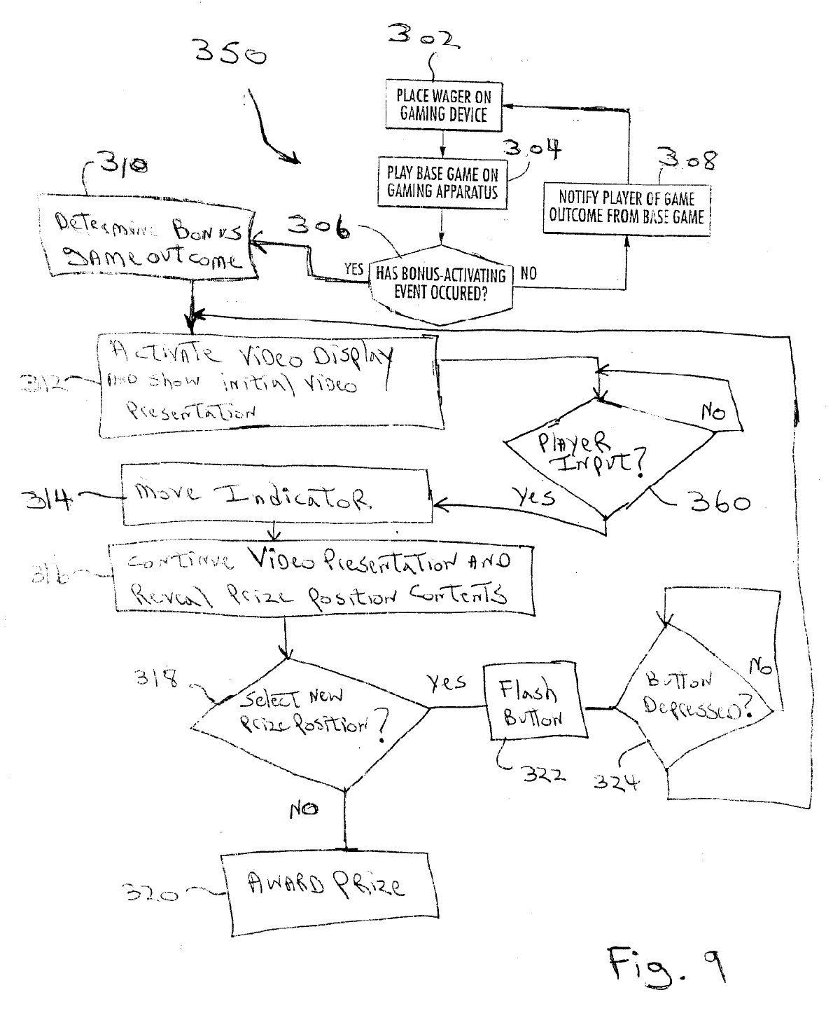

Referring to FIG. 9, another gaming method 350 is shown. Gaming method 350 is similar to gaming method 300 except that decision 360 to allow player input has been added. A player places a wager on gaming apparatus 20 in step 302. Method 350 proceeds to allow the player to play a game and determine a game outcome in step 304. At decision 306, method 350 checks to see if the game outcome determined in step 304 is an outcome qualifying the player to play a bonus game. If not, method 350 proceeds to step 308, notifies the player of the game outcome and awards the player any prizes awarded according the game outcome determined in step 304 and returns to step 302.

If it is determined in step 306 that the game outcome of step 304 qualifies the player for a bonus game, method 350 proceeds to step 310. At step 310, controller 176 randomly determines the game outcome or prize. At step 312, video display 100 is activated and an initial video presentation is presented. This may include activation of player input devices 114, 116 and 118. Lights and sounds may also be activated to make the event more exciting to the player and those around the player, as well as to call attention to the device.

Method 350 proceeds to decision 360, which checks to see whether one of player input devices 114 or 116 has been selected by the player in order to determine the position of indicator 60. If player input devices 114 or 116 have not been selected, method 350 waits for player input. If no input has been received after a pre-determined period of time, for example, 1 minute, controller 176 may make a selection for the player. If decision 360 determines that the player has selected one of player input devices 114 or 116, method 350 proceeds to step 314. At step 314, indicator 60 is moved by positioning mechanism 72 to the position indicated by the player in step 360. Indicator 60 is moved until it is stopped and aligned with the selected row 106 on video display 100. At step 316, controller 176 continues to present the video presentation including displaying a prize indicia 112 in a prize position 104. Therefore, in combination, the indicator and the video display point to prize indicia that corresponds to the game outcome. At decision 318, controller 176 checks to see if the result of step 316 is a prize award. If the result of step 316 is a prize award, method 350 proceeds to step 320 and awards any prizes. If the result of step 316 is not a prize award, method 350 proceeds to step 322. At step 322 a button 118 is illuminated or flashed. At decision 324, controller 176 checks to see if button 118 has been depressed. If button 118 has not been depressed, method 350 returns to decision 324 to await depression of button 324. If no input has been received after a pre-determined period of time, for example, 1 minute, controller 176 may make a selection for the player.

After button 118 has been depressed, method 350 proceeds to step 312 in order to repeat the bonus game steps of 312, 314, 316 and 318. These steps can be repeated a multiple number of times until a prize is selected to be awarded by controller 176 at step 320.

Many variations of method 350 can be made without departing from the scope of the present invention. For example, the bonus game could be played separately without the use of base game apparatus 21. In an alternative embodiment, the player may be allowed to position indicator 60 after the game has begun.

Various additions, subtractions, and permutations of the steps in the above described methods can be made without departing from the scope of the present invention. The more the player is allowed to interact with gaming apparatus 20, the more control over the outcome of the game the player may feel, which may make the game more enjoyable to the player. Of course, regulatory concerns may dictate that the player's perceived control be largely or completely illusionary.

It is noted that the flowcharts of FIGS. 8 and 9 show only one possible embodiment. Some of the steps in the flowchart may be varied, changed in order, or eliminated and still fall within the scope of the present invention.

### ADDITIONAL EMBODIMENT

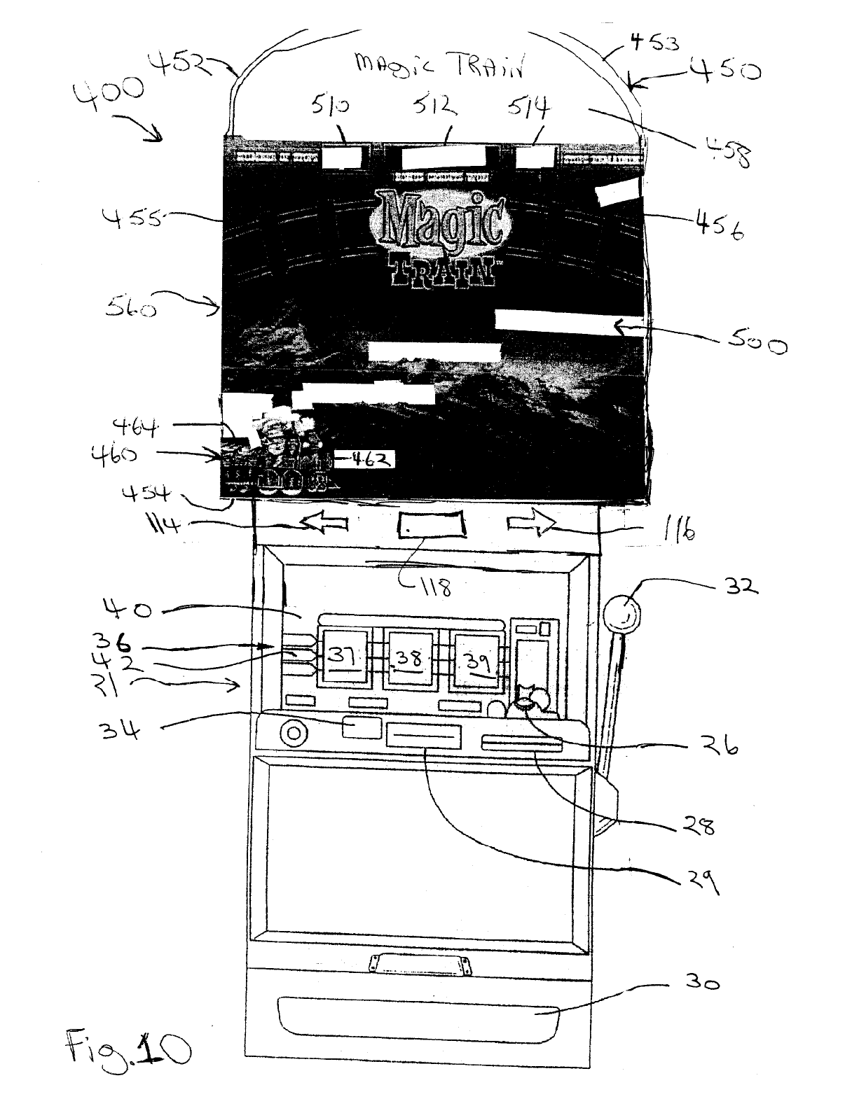

Referring to FIG. 10, an additional embodiment of a gaming apparatus 400 in accordance with the present invention is shown. Gaming device 400 comprises a bonus game or second display 450 and a primary gaming device 21. Gaming device 21 has the same structure and operation as previously described for gaming apparatus 20 of FIG. 1.

Gaming apparatus 400 may include a bonus game or second display 450 configured to display at least one game and prize to a player. In at least one embodiment, second display 450 is configured to display a bonus game and at least one bonus prize to the player. In other embodiments, second prize display 450 may provide a primary game. Alternatively, second prize display 450 may be a stand-alone device allowing a player to place a wager and play a game.

In at least one embodiment, second display 450 is attached to gaming device 21 and positioned on top of gaming device 21. In other embodiments (not shown), second display 450 may be separate from gaming device 21 but in communication with gaming device 21. In this embodiment, second display 450 may be in communication with a plurality of different gaming devices 21 via a computer network in a manner that is well known in the art. Second display 450 may also be positioned adjacent to or remote from gaming device 21. In other embodiments, second display 450 is a stand-alone display not in communication with gaming device 21, and it may be capable of independently accepting wagers, conducting games, and awarding prizes to a player.

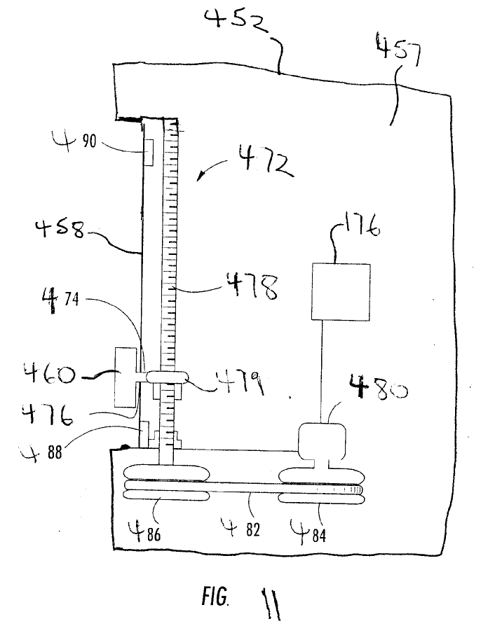

With continued reference to FIG. 10, second display 450 may comprise a housing 452. Housing 452 may be arc-shaped and comprise a top 453, a bottom 454 and side walls 455 and 456. The walls define an internal space or cavity 457 (see FIG. 11). Of course, housing 452 may be made in many different shapes. Second display 450 also may have a video display 500 and a moveable mechanical indicator 460. Video display 500 and indicator 460 may be positioned within housing 452.

A decorative front panel 458 may cover portions of housing 450. Front panel 458 can also include a display (not shown) for displaying the amount of credits or the amount of a prize that is won during the game. Video display 500 can be a variety of video displays such as liquid crystal, cathode ray tube, plasma or projection displays.

The video presentations displayed on display 500 may be a wide variety of video presentations such as bonus presentations, a presentation to attract players to game apparatus 400, or a presentation to provide information to players.

The video presentation shown on display 500 may be designed in various forms and preferably according to a theme of a game. In the example shown in FIG. 10, the theme of the game is a moving train that awards players various payouts. In an embodiment, display 500 can show a moving background such as mountains, lakes, cities, trees and rivers. In FIG. 10, an initial screen shot 560 is shown on video display 500. Screen shot 560 comprises a portion of a video presentation designed to attract game players during periods when game apparatus 400 is not being played.

Screen shot 560 includes representations of several game meters or counters. Screen shot 560 includes a number of stops meter 510, a bonus credits won meter 512 and a number of stops remaining meter 514.

Indicator 460 may be a variety of indicators, including two and three-dimensional indicators. Indicator 460 may be configured to move horizontally (left and right) relative to video display 500 in response to signals sent by a controller (to be described later). The number of indicators 460 may vary, and the direction of their movement may vary, and may include horizontal, zigzag, and/or diagonal movements.

The shape or appearance of indicator 460 may be designed in various forms and preferably according to a theme of a game. In the example shown in FIG. 10, the theme of the game is a moving train that awards players various payouts. Accordingly, indicator 460 is in the form of a locomotive 462 and railcar 464. The locomotive 462 and railcar 464 may appear to moving in conjunction with video display 500. A video presentation of a moving background is presented on video display 500. The video display 500, in combination with mechanical indicator 460, appears to a game player to interact and present an integrated unified image in an entertaining manner.

Alternatively, indicator 460 may be other types of indicators or pointers, such as an arrow. Indicator 460 could also be another type of moving object such as a boat, car, airplane, submarine, motorcycle or bicycle. The present invention is not limited to any particular type of indicator or pointer, or any particular representation of an indicator or pointer.

Referring now to FIG. 11, indicator 460 may be coupled to a positioning mechanism 472 by a bracket 474. Positioning mechanism 472 may be located within the confines of housing 452. A slot 476 in the front panel 458 may be provided, which allows bracket 474 to pass through the front panel. Positioning mechanism 472 may comprise a horizontally oriented threaded rod or worm gear 478 that is rotatable. Indicator 460 may be attached to worm gear 478 by a bracket 474 that is attached to a nut 479 threaded on worm gear 478. Actuator 480 drives a driving pulley 484, which is connected with a driven pulley 486 through a drive belt 482. Actuator 480 is in communication with controller 176. Driven pulley 486 is attached to one end of worm gear 478. Rotation of actuator 484 causes rotation of worm gear 478 and movement of indicator 460.

Sensors 488 and 490 may be provided to allow a bonus game controller 176 or other control mechanisms (not shown), to detect the position of indicator 460. While indicator 460 is shown to move horizontally in FIG. 2, it may be moved in any desired manner, including vertically, diagonally, or in a non-linear fashion, such as in a rotating or zigzag manner.

In another embodiment, a wheel (not shown) may be attached to actuator 480. The periphery of the wheel may have at least one notch detectable by a sensor (not shown) and used by a bonus game controller 176. Wheel and worm gear 478 may be rotated together by actuator 480. The sensor monitors the position of indicator 460 by detecting the notch. Bonus game controller 176 may store information pertaining to the number of times the sensor has detected the notch and the corresponding position of moveable indicator 460. An optical interrupt (not shown) may be provided to reset the indicator position information. The sensor may be an infrared source and detector. In alternative embodiments, the periphery of the wheel may comprise portions with different reflective characteristics, such as absorbent paint lines, instead of a notch on the wheel. Actuator 480 may be a stepper motor, a servomotor, a gear motor, a solenoid, a rack and pinion, or other actuators known in the art.

Turning to FIG. 10, bonus or second display 450 also has player-input devices 114, 116 and 118 that allow the player to indicate his or her choice. In one embodiment, player input devices 114 and 116 are buttons that allow the player to select the direction of movement of a display portion of video display 500 or indicator 460. Alternatively, a touch screen (not shown) may be provided in place of or in addition to buttons 114 and 116.

Player-input device 118 can be a button that allows the player to select another prize or window to display another prize. For example, if the game player does not receive a prize or is dissatisfied with the prize awarded, player input device 118 can be flashed or illuminated. After player input device 118 is depressed, the game would select and display another prize.

Player input devices 114, 116 and 118 allow a game player to partially control the outcome of bonus game 450. While the player is allowed to make a selection, controller 176 controls the final prize that is displayed and awarded.

The use of the player-input devices 114, 116 and 118 provides the game player with the illusion of a sense of control over the game. Of course, regulatory concerns may dictate that the player's perceived control be largely or completely illusionary.

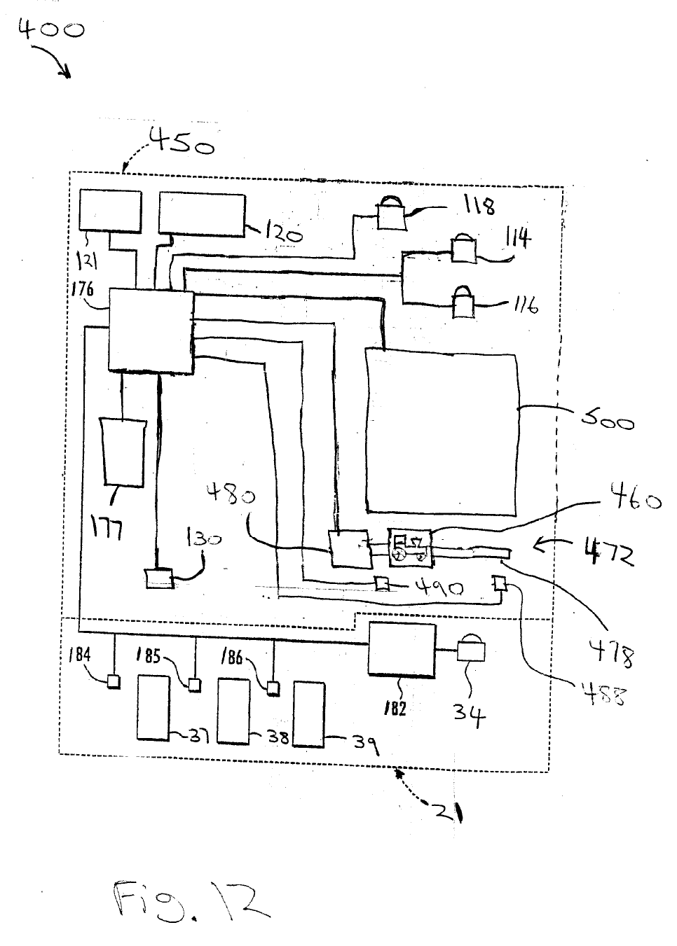

Turning now to FIG. 12, second display 450 comprises a controller 176 that is adapted to control the operation of the game apparatus. Controller 176 may be one or more computers or processor boards. For example, in the presently implemented embodiment, controller 176 can be a bonus controller and stepper motor controller. Controller 176 and controller 182 may be combined in a single processor or processor board.

Controller 176 is adapted to detect when a bonus activating event occurs in game apparatus 21. This may be accomplished by game apparatus controller 182 transmitting a signal to controller 176 that a bonus event has occurred. For example, controller 182 may determine the outcome of each game and when a bonus-activating outcome occurs, it transmits a signal to controller 176. Alternatively, controller 176 may periodically interrogate controller 182. In another embodiment, one or more sensors may be provided for determining if a bonus activating event has occurred. For example, sensors 184-186 may sense the positions of reels 37-39. When reels 37-39 are in a bonus activating position, controller 176 would sense this position and begin a bonus sequence (described below). Sensors may also be provided external to gaming device 20 to detect external bonus-activating events.

Controller 182 may also transmit a variety of information to controller 176. For example, controller 182 may signal when coins or currency have been inserted, when a game starts, when an error has occurred, and when a sensor detects tampering.

When controller 176 detects a bonus-activating event, it may begin a bonus sequence by activating video display 500 and/or indicator 460. Video display 500 may present an entertaining video presentation after the bonus qualifying event. Another display (not shown) may indicate that a player has qualified for a bonus round and prompt the player to perform an action. In an embodiment, the player is prompted to activate the bonus sequence by pressing input device 118. Input device 118 may be a simple button, a keyboard, or a touch screen display. In the embodiment in which the player must accumulate a number of bonus symbols to qualify for a bonus, video display 500 may indicate the number of symbols the player has received.

Controller 176 is in communication with a video storage unit 177. Video storage unit 177 can be a wide variety of devices, such as solid state memory, disk drives, compact discs or videotape. Video storage unit 177 can store a wide variety of video presentations.

When controller 176 detects input device 118 being activated, the controller would activate video display 500 and present a video presentation from video storage unit 117 on video display 500. Alternatively, a video presentation on video display 500 may begin automatically after the detection of a bonus qualifying event. In another embodiment, controller 176 may wait a predetermined time period for the player to activate input device 118. If the player does not activate input device 118 in that time period, controller 176 would automatically activate display 500.

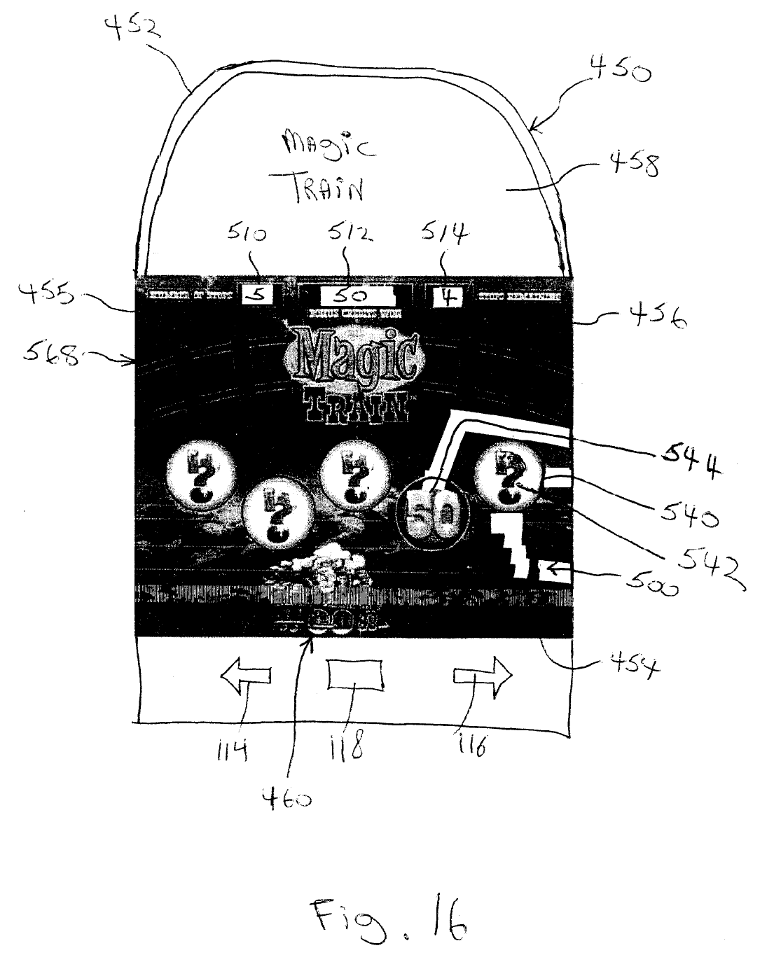

Controller 176 performs a routine to determine which prize indicia 544 (see FIG. 16) will be displayed to the game player in a particular prize position 540 (FIG. 16). Prize indicia 544 can represent various things, including prize amounts, multipliers, a description or representation of merchandise or services, progressive prizes, or jackpot prizes.

This may be performed by a number of methods that are well known in the art. For example, the prize indicia may be sequentially displayed or displayed based on external events.

In one embodiment, however, prize indicia 542 are randomly selected. Controller 176 generates a random number and then compares the random number to a pay table similar to that described for game apparatus 21 or as described in U.S. Pat. No. 5,823,874, issued to Adams. A simple pay table may appear as follows:

TABLE 1

| Random | Bonus | |
|---|---|---|
| Number | Credits | Amount Paid |
| 0.00 to 0.50 | 5 | $5.00 |
| 0.51 to 0.75 | 10 | $10.00 |
| 0.76 to 0.95 | 20 | $20.00 |
| 0.96 to 1.00 | 75 | $75.00 |

For example, if the random number generator produced 0.65, 10 credits would be displayed and $10.00 would be awarded to the player. If the random number generator produced 0.80, 20 credits would be displayed. Other awards, such as prize multipliers of some amount produced by game apparatus 450, can also be used. Gaming apparatus 450, for instance, may award $20 and the multiplier prize indicia would multiply this by two, awarding the player $40.

This embodiment is not necessarily limited to the example pay table shown. A greater number of prizes awards may be used and, as will be discussed below, a combination of prizes may be displayed. Furthermore, different kinds of prizes, besides monetary prizes, may be awarded. For example, the prizes may be goods, services, or additional games. The goods and services may be awarded in the form of physical objects, tickets, vouchers, coupons, etc. Additional games may be presented in the form of tickets, such as scratch off lottery tickets. In the embodiments in which tickets, vouchers, and coupons are used, the objects are dispensed using an internally or externally mounted dispenser 121. Such dispensers are well known in the art.

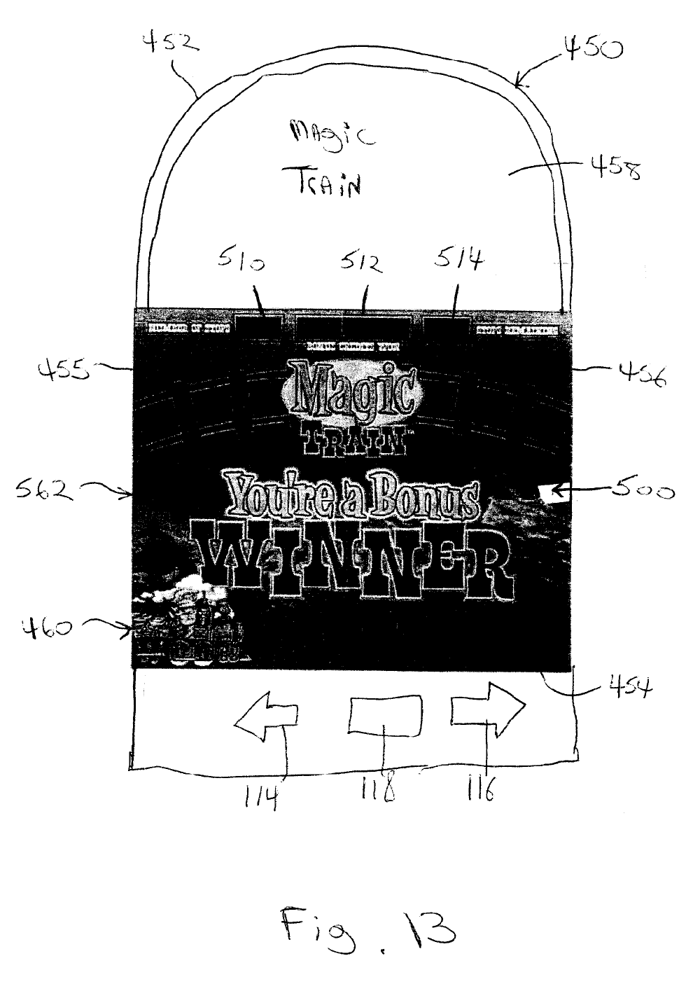

Once controller 176 determines the prize indicia to be displayed and the prize to be awarded, the controller activates video display 500. Turning to FIG. 13, a second screen shot 562 of a video presentation on display 500 is shown. The screen shots are displayed sequentially on video display 500. In FIG. 13, display 500 can show a video presentation informing the game player that they have qualified to play a bonus game. Sound effects of a train or train whistle can also be presented during the video presentation on speaker 130 (FIG. 12). Indicator 460 can be moved during activation of video display 500. Indicator 460 can be in an initial position near side 455.

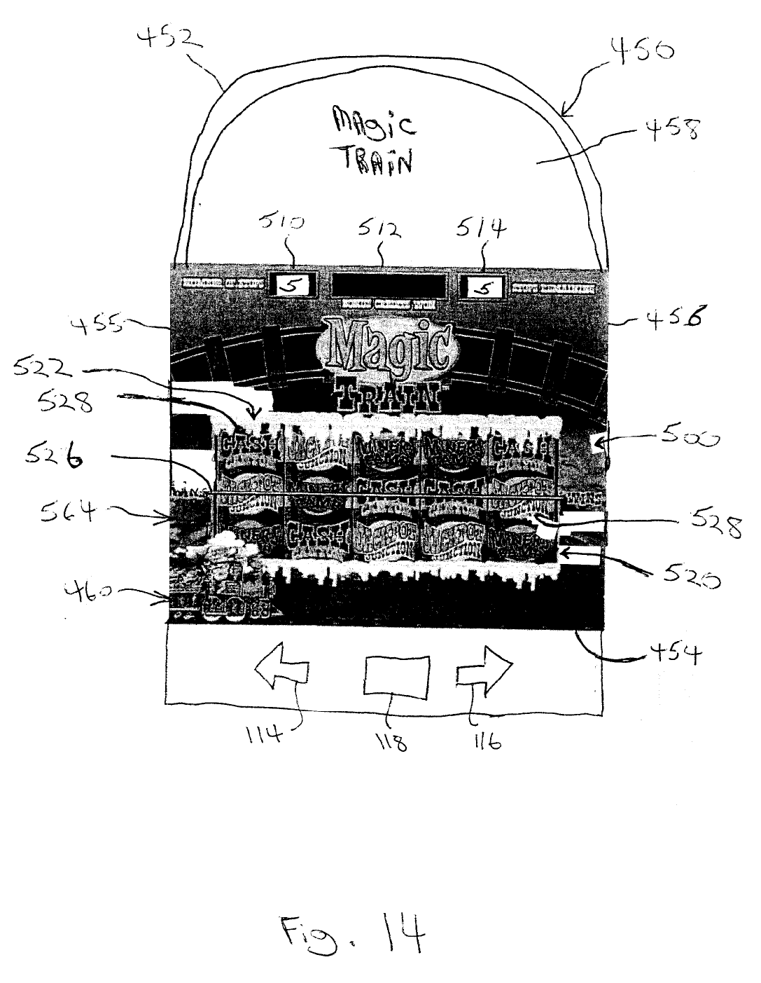

Referring to FIG. 14, a third screen shot 564 of a video presentation on video display 500 is shown. In FIG. 14, video display 500 can show a video presentation of video reels 520 being rotated. Video reels 520 have five individual reels 522 and a payline 526. Reels 522 contain game cycle or train destination indicia 528. Video reels 522 are rotated and stopped such that five train destination indicia 528 are indicated by payline 526. Three different train destination indicia are shown, Cash Canyon, Jackpot Junction and Miners Camp.

Each train destination indicia 528 that is aligned with payline 526 represents a game cycle or stop at a train destination. For the example shown in FIG. 14, two stops are shown at Jackpot Junction, one a Miners Camp and two at Cash Canyon. The total number of game cycles or train stops are shown on meter 510 and the total number of game cycles or train stops remaining are shown on meter 514. In FIG. 14, 5 total train stops and 5 train stops remaining are shown.

Alternatively, one or more blank spaces could be placed on video reel 522 in order to award less than five train stops. If the payline were aligned with a blank space, no train stop would be allotted.

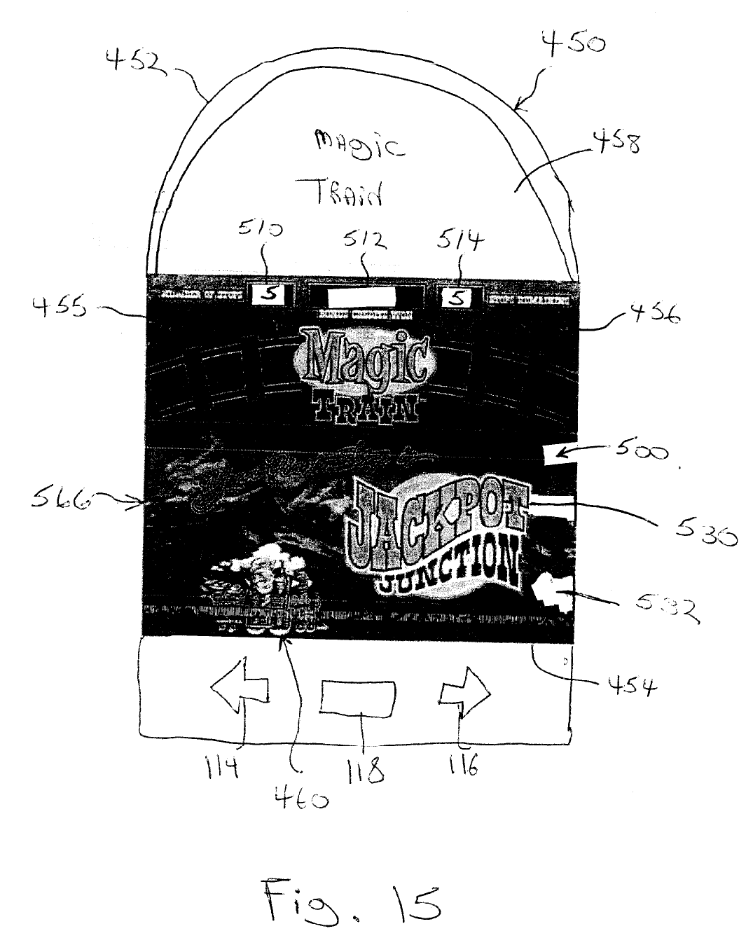

Referring to FIG. 15, a fourth screen shot 566 of a video presentation on video display 500 is shown. In FIG. 15, video display 500 can show a video presentation related to the first train destination. The first train destination shown is Jackpot Junction. A Jackpot Junction sign or symbol 530 is shown on video display 500. Other destination specific information and video can also be presented during the video presentation. Screen shot 566 can also be shown to have a background 532 that moves from side 456 toward side 455.

After the screen shot 566 has been started, controller 176 can direct positioning mechanism 472 to move mechanical indicator 460 to a position to be in alignment with a first stop position. Actuator 480 causes worm gear 478 to rotate moving indicator 460. Sensors 488 and 490 are in communication with controller 176. Sensors 488 and 490 can determine the position of indicator 460. Indicator 460 can be stopped at the location determined by controller 176.

It is noted that the video presentation is designed such that it appears that the train is moving forward much faster than in reality due to the fact that the background 532 is moving in the opposite direction. Sound effects of a moving train can also be presented during this portion of the video presentation. The use of mechanical indicator 460 and video display 500 appear to a game player to interact as unified integrated presentation. The mechanical indicator appears to interact with the video presentation and provides an illusion of a fast moving train that is in motion.

Turning to FIG. 16, a fifth screen shot 568 of a video presentation on display 500 is shown. In FIG. 16, display 500 can show a video presentation of several prize positions 540 at the train destination that display a symbol 542. A prize indicia 544 is shown in one of prize positions 540. In the example shown in FIG. 16, prize indicia 544 shown is an award of 50 credits. Prize indicia 544 can represent any type of prize including no prize.

Prize indicia 544 can be displayed in the video presentation in several manners. In one embodiment, indicator 460 points to the prize position 540 in which a prize indicia 544 is shown. In another embodiment, prize positions 540 can be flashed or illuminated in sequence and one of the prize positions randomly selected to display a prize indicia 544.

In another embodiment, the video presentation can be partially controlled by the game player using player input devices 114, 116 and 118. For example, one of prize positions 540 can be flashed or illuminated. The game player can move the flashing prize position to the left by depressing player input device 114. The game player can move the flashing prize position to the right by depressing player input device 116. After the game player has selected one of the prize positions, the player depresses flashing button 118. The video presentation then proceeds to display a prize indicia 544 in the selected prize position 540.

After prize indicia 544 has been shown, controller 176 can cause the video presentation to display the prize credits, if any, won on meter 512. Screen shot 568 shows 50 credits won on meter 512. Display 500 also shows five total stops on meter 510 and four remaining stops on meter 514. Other effects may also be presented, such as pre-recorded sound from speakers. If the actual prize is money, the prize may be dispensed from dispenser 121 or coin dispenser 30.

Combinations of prize indicia 544 can be used to indicate various bonus outcomes. For example, the contents of several prize positions 540 could be revealed and added together and awarded as a total prize to the game player.

In an alternative embodiment, the contents of prize positions 540 could be shown during a video presentation. Indicator 460 could then be positioned and appear to interact with the video presentation to indicate which prize position 540 displays the game outcome.

It is also possible to replace the primary display of a gaming device with second display 450. Game apparatus 21 may be entirely replaced by second display 450. In other words bonus gaming apparatus 450 can be used as a primary or base game apparatus.

In another embodiment, the player could be allowed to use player input devices 114, 116 and 118 to select which prize position 540 that indicator 460 points to.

After the video presentation updates meter 512 with the credits won, video display 500 can show a video presentation of the next train destination similar to screen shot 566 in FIG. 14. The next train destination was previously determined using video reels 520.

The video presentation partially shown in screen shot 568 of FIG. 16 is then repeated for each selected train destination until all selected train destinations have been visited and all prizes have been awarded and added to meter 512.

After each train destination is visited, train stop meter 514 is decreased by one until no further train stop destinations are left.

Other effects may also be presented on video display 500, for example an entertaining non-game related video presentation can be shown. The non-game related video may be presented before the game has begun in an attract mode or can be presented during the game in order to enhance the entertainment value of the game.

Gaming Method

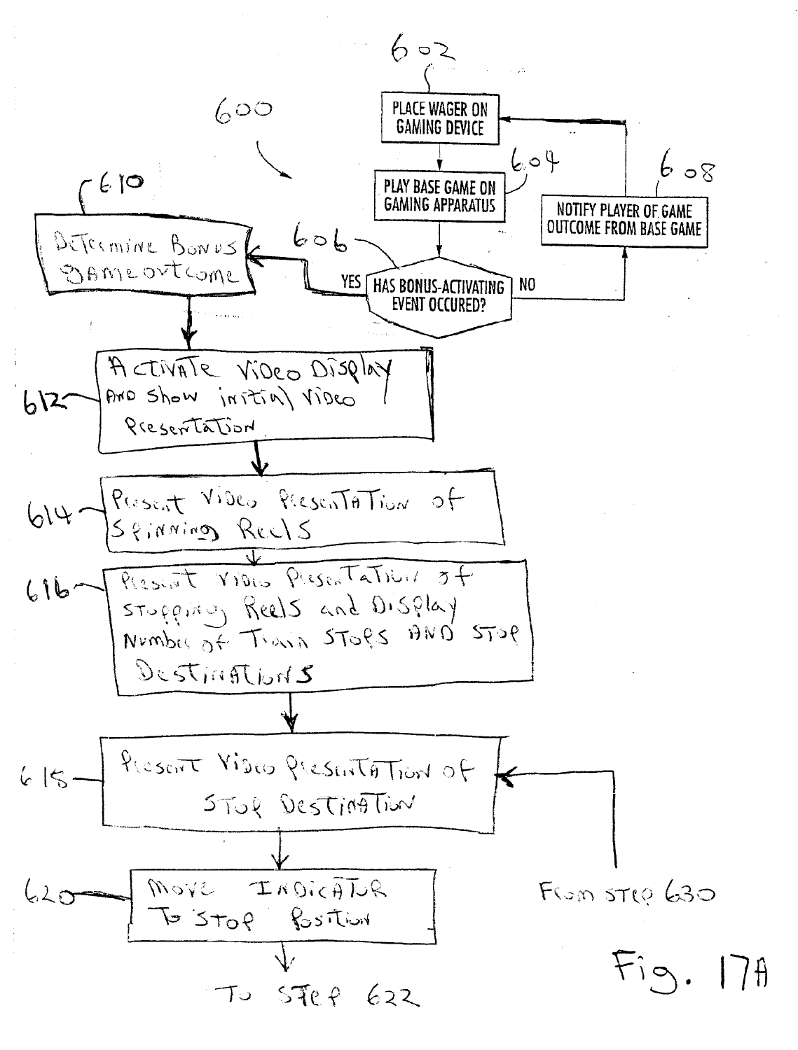

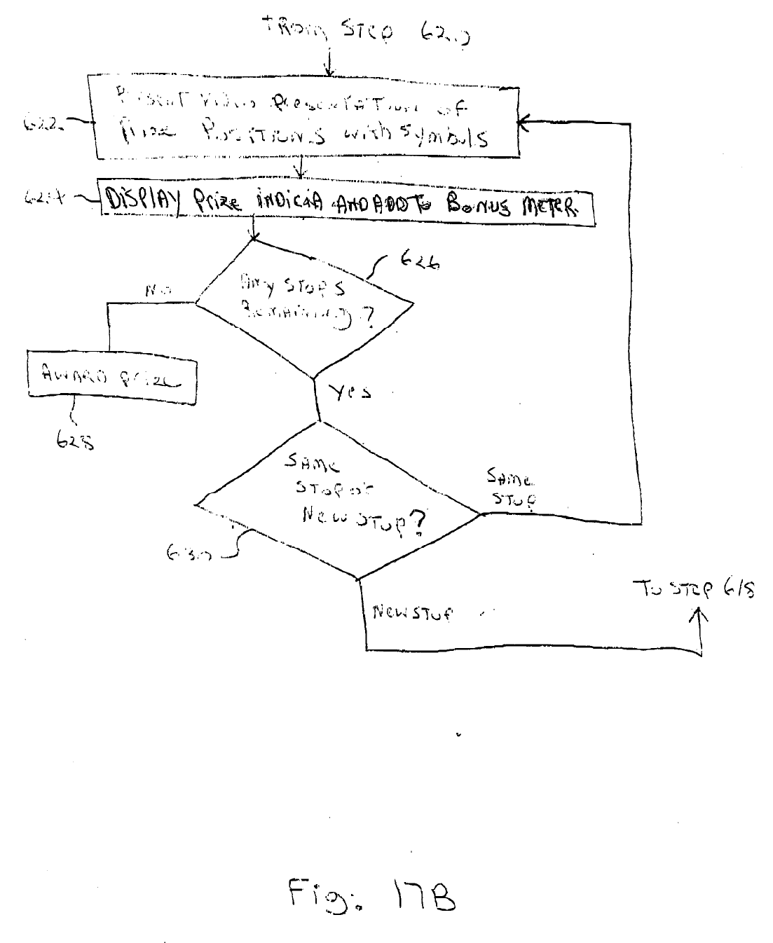

One method of operation 600 of gaming apparatus 400 of the present invention is illustrated in FIGS. 17A and 17B. A player places a wager on gaming apparatus 400 in step 602. Method 600 proceeds to allow the player to play a game and determine a game outcome in step 604. At decision 606, method 600 checks to see if the game outcome determined in step 604 is an outcome qualifying the player to play a bonus game. If not, method 600 proceeds to step 608, notifies the player of the game outcome and awards the player any prizes awarded according the game outcome determined in step 604 and returns to step 602.

If it is determined in step 606 that the game outcome of step 604 qualifies the player for a bonus game, method 600 proceeds to step 610. At step 610, controller 176 randomly determines the game outcome or prize. At step 612, video display 500 is activated and an initial video presentation is presented. This may include activation of player input devices 114, 116 and 118. Lights and sounds may also be activated to make the event more exciting to the player and those around the player, as well as to call attention to the device.

Method 600 then proceeds to step 614. At step 614, video display 500 shows a video presentation of video reels 520 being rotated. Next, at step 616, video reels 520 are stopped such that the game cycles or train destinations are indicated. The total number of train stops is shown on meter 510 and the total number of train stops remaining is shown on meter 514 of video display 500.

Method 600 then proceeds to step 618. At step 618, method 600 presents a video presentation related to the first train destination. Next, at step 620, controller 176 can direct positioning mechanism 472 to move mechanical indicator 460 to a position to be in alignment with a stop position.

Method 600 then proceeds to step 622, where a video presentation can be presented that shows several prize positions 540. Next, at step 624, a video presentation is shown of at least one prize indicia 544 being displayed. Also at step 624, meter 514 is decreased by one to show the number of stops remaining.

At decision 626, controller 176 checks meter 514 to see if any train stops are remaining that have not been visited. If no train stops are remaining to be visited, method 600 proceeds to step 628 where any prizes are awarded. If any train stops remain to be visited, method 600 proceeds to decision 630.

At decision 630, controller 176 checks to see if the next train stop is the same as the current train stop. If the next train stop to be visited is the same as the current train stop, method 600 proceeds to step 622 in order to repeat step 622 at the same train stop. If the next train stop is a new train stop, method 600 proceeds to step 618 in order to repeat step 618 for a new train stop destination.

Many variations of method 600 can be made without departing from the scope of the present invention. For example, the number of train stop destinations indicated by reels 520 that are the same could be used as a multiplier to multiply the amount shown by prize indicia 544 as an award. Alternatively, the bonus game could be played separately without the use of base game apparatus 21.

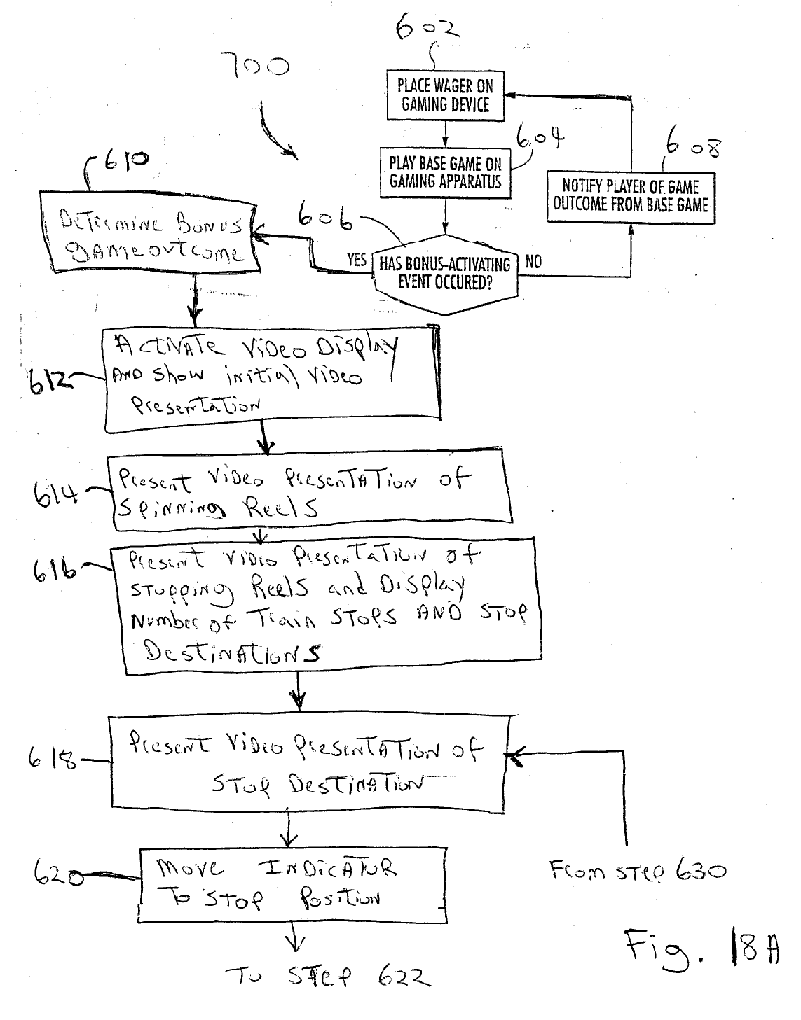

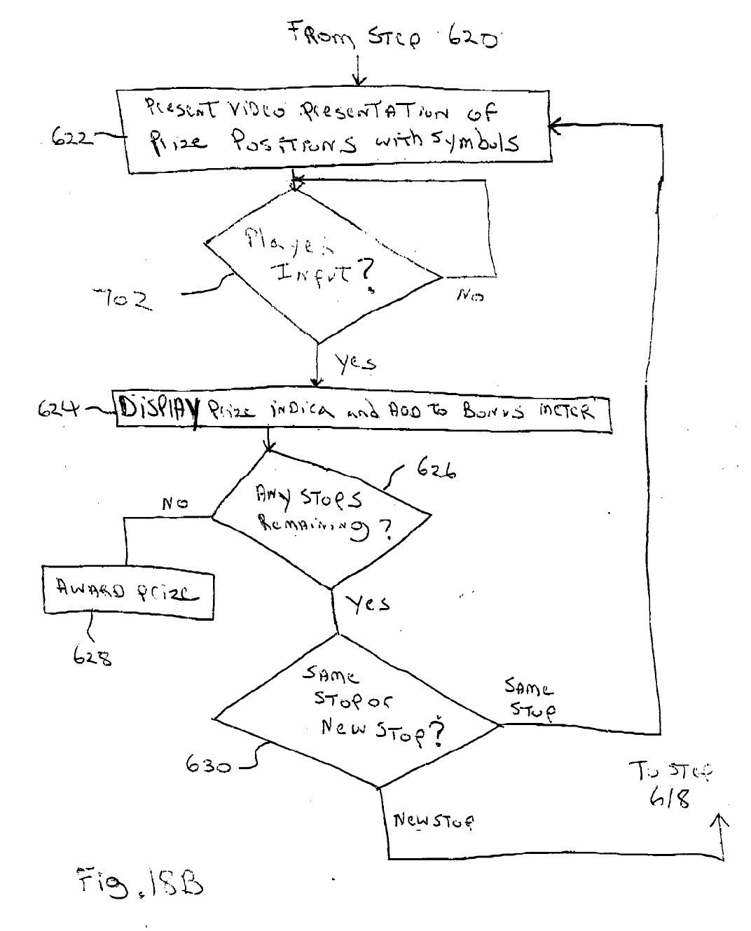

Another method of operation 700 of gaming apparatus 400 of the present invention is illustrated in FIGS. 18A and 18B. Gaming method 700 is similar to gaming method 600 except that decision 702 to allow player input has been added between step 622 and step 624.

Decision 702 checks to see whether one of player input devices 114 or 116 has been selected by the player in order to determine which prize position 540 that a prize indicia 544 will be shown in. If player input devices 114 or 116 have not been selected, method 702 waits for player input. If no input has been received after a pre-determined period of time, for example, 1 minute, controller 176 may make a selection for the player. If decision 702 determines that the player has selected one of player input devices 114 or 116, method 702 proceeds to step 624. Decision 702 can include depression of button 118. At step 624, a video presentation is shown of at least one prize indicia 544 being displayed. The rest of method 700 proceeds the same as was previously described for method 600.

Various additions, subtractions, and permutations of the steps in the above described methods can be made without departing from the scope of the present invention. The more the player is allowed to interact with gaming apparatus 400, the more control over the outcome of the game the player may feel, which may make the game more enjoyable to the player. Of course, regulatory concerns may dictate that the player's perceived control be largely or completely illusionary.

It is noted that the flowcharts of FIGS. 17A, 17B and 18A, 18B show only one possible embodiment. Some of the steps in the flowchart may be varied, changed in order, or eliminated and still fall within the scope of the present invention.

### CONCLUSION

It can thus be realized that certain embodiments of the present invention provide a highly attractive and entertaining device for displaying prizes. Certain embodiments of the present invention further provide a moveable indicator and video display to indicate a bonus prize. Certain embodiments of the present invention provide a mechanical indicator that interacts with a video presentation such that a unified integrated presentation is shown. Thus, certain embodiments of the present invention can easily catch patrons' attention and invite patrons to play the game. Certain embodiments may further cause players to play longer because the display device enhances the anticipation, stimulation, and excitement experienced by players.

Although the description above contains many specifications, these should not be construed as limiting the scope of the invention but as merely providing illustrations of some of the present embodiments of this invention. Thus, the scope of the invention should be determined by the appended claims and their legal equivalents rather than by the examples given.

What is claimed is:

1. A gaming device comprising:
(A) a video display, the video display being adapted to display a plurality of prize positions;
(B) a moveable indicator configured to indicate at least one of the prize positions; and
(C) a controller in communication with the video display and the moveable indicator, the controller configured to cause the moveable indicator to indicate at least one prize position and cause the video display to display a video presentation on the video display, the controller further configured to cause the video display to display a prize indicia in the prize position indicated by the moveable indicator.

2. The gaming device of claim 1 wherein the moveable indicator is configured to indicate a plurality of prize positions and the moveable indicator and video display together indicate one of the plurality of prize positions indicated by the indicator.

3. The gaming device of claim 1, wherein the controller directs the video display and the mechanical indicator to operate in a coordinated manner such that it appears that the mechanical indicator and video display are operating in an integrated manner.

4. The gaming device of claim 1, wherein a player input device is in communication with the controller, the player input device configured to allow a game player to select a prize position that can be indicated by the moveable indicator.

5. The gaming device of claim 4, wherein the controller reveals the prize indicia after the game player selects the prize position that the moveable indicator points toward.

6. The gaming device of claim 1, wherein the moveable indicator is a fire hose.

7. The gaming device of claim 1, wherein the moveable indicator is a vehicle.

8. A gaming method comprising, but not necessarily in the order shown:
(A) displaying a video presentation on a video display, the video presentation containing a plurality of prize positions;
(B) determining a game outcome, the game outcome corresponding to, and being conveyable by, at least one prize indicia;
(C) positioning a moveable indicator to point to the video display;
(D) moving the moveable indicator such that the moveable indicator indicates at least one of the prize positions; and
(E) displaying the prize indicia at the prize position that the moveable indicator indicates.

9. The method of claim 8, further comprising awarding a prize.

10. The method of claim 8, further comprising displaying a non-game related video presentation.

11. The method of claim 8 further comprising:
(A) providing a player input device;
(B) allowing the player to at least partially control the movement of the moveable indicator using the player input device.

12. The method of claim 8 further comprising:
(A) providing a player input device;
(B) allowing the player to select the prize position using the player input device.

13. A gaming apparatus comprising:
(A) a video display, the video display being configured to display at least one video presentation;
(B) at least one moveable mechanical indicator positioned so that the indicator and the video display can be viewed together; and
(C) a controller in communication with video display and the moveable mechanical indicator, the controller configured to cause the moveable indicator to move and cause the video display to display a video presentation wherein when viewed together, the moveable mechanical indicator enhances the video presentation.

14. The gaming apparatus of claim 13, wherein the moveable mechanical indicator can move across the video display in at least one axis.

15. The gaming apparatus of claim 13, wherein the moveable mechanical indicator is attached to at least one threaded rod.

16. The gaming apparatus of claim 13, further comprising an actuator coupled to the mechanical indicator and in communication with the controller.

17. The gaming apparatus of claim 13 further comprising a player input device in communication with the controller, the player input device allowing the player to at least partially control the movement of the moveable mechanical indicator.

18. The gaming apparatus of claim 17 wherein the player's input has no affect on the game outcome.

19. A gaming device comprising:
(A) video display means for displaying a plurality of prize indicia;
(B) indicator means for indicating at least one of the prize indicia;
(C) positioning means for positioning the indicator means; and
(D) controller means for causing the indicator means and the video display means, in combination, to indicate a game outcome.

20. The gaming device of claim 19, further comprising player input means in communication with the controller means, the player input means allowing a player to at least partially control movement of the indicator means.

21. A gaming method comprising, but not necessarily in the order shown:
(A) determining a number of game cycles to be played;
(B) presenting a video presentation containing a plurality of prize positions;
(C) moving a mechanical indicator in coordination with the video presentation;
(D) displaying a prize indicia in one of the prize positions; and
(E) repeating (B) through (D) a number of times equal to the number of games cycles minus one.

22. The method of claim 21, further comprising displaying the number of game cycles.

23. The method of claim 21 further comprising allowing a player to at least partially select which prize position the prize indicia is displayed in.

24. The method of claim 21, further comprising adding each prize indicia displayed together to obtain a total prize indicia displayed and displaying a total prize indicia displayed.

25. The method of claim 21, further comprising displaying the number of game cycles remaining to be played.

26. A gaming apparatus comprising:
(A) a video display, the video display being adapted to display a plurality of possible game outcomes;
(B) at least one moveable mechanical indicator mounted with the video display; and
(C) a controller in communication with video display and the moveable mechanical indicator, the controller configured to cause the moveable indicator to move and to cause the video display to display a video presentation, wherein the moveable mechanical indicator and the video presentation in combination convey the game outcome.

27. The gaming apparatus of claim 26, wherein the video presentation is repeated a predetermined number of cycles.

28. The gaming apparatus of claim 26, further comprising displaying the total number of times the video presentation is displayed.

29. The gaming apparatus of claim 28, further comprising displaying the remaining number of times the video presentation is to be displayed.

30. The gaming apparatus of claim 26, wherein the indicator is a vehicle.

31. The gaming apparatus of claim 26, wherein the indicator is a fire hose.

32. The gaming apparatus of claim 26 further comprising a player input device in communication with the controller, the player input device allowing the player to at least partially control the movement of the moveable mechanical indicator.
